(19) United States
(12) Patent Application Publication
(10) Pub. No.: US 2011/0153193 A1
(43) Pub. Date: Jun. 23, 2011

(54) NAVIGATION SYSTEMS AND METHODS FOR USERS HAVING DIFFERENT PHYSICAL CLASSIFICATIONS

(75) Inventors: Stephen Anthony Fox, Barrington, IL (US); Eric Garland, Barrington, IL (US); William Vesely, Barrington, IL (US); Rex Roeges, Barrington, IL (US)

(73) Assignee: General Electric Company, Schenectady, NY (US)

(21) Appl. No.: 12/644,872

(22) Filed: Dec. 22, 2009

(51) Int. Cl. G01C 21/00

(52) U.S. Cl. 701/201

(57) ABSTRACT

Navigation systems and methods for users having different physical classifications are described. An example method of navigating a user to a destination based on a selected physical classification includes identifying, based on user selection, the physical classification associated with the user and the destination and determining a route to the destination to accommodate the selected physical classification. Additionally, the example method includes conveying the route to the user and alerting the user of one or more items of interest associated with the selected physical classification and the determined route.

### BACKGROUND

Navigation systems, such as the global positioning system (GPS), may be used to develop routes to specified destinations. Such routes may be developed based on a user's current position or a specified start point, for example. Some navigation systems enable users to specify the mode of transportation (e.g., walking, public transportation or driving) and may provide different routes depending on the mode of transportation chosen.

### SUMMARY

An example method of navigating a user to a destination based on a selected physical classification includes identifying, based on user selection, the physical classification associated with the user and the destination and determining a route to the destination to accommodate the selected physical classification. Additionally, the example method includes conveying the route to the user and alerting the user of one or more items of interest associated with the selected physical classification and the determined route.

An example tangible machine readable medium having instructions stored thereon that, when executed, cause a machine to identify, based on user selection, a physical classification associated with the user and a destination and determine a route to the destination to accommodate the selected physical classification. Additionally, the example tangible machine readable medium having instructions stored thereon that, when executed, cause the machine to convey the route to the user and alert the user of one or more items of interest associated with the selected physical classification and the determined route.

An example system configured to navigate a user to a destination based on a selected physical classification includes a processor configured to determine a route to the destination based on the selected physical classification, wherein the processor is to convey the route to the user and a data store to store data associated with the route and the selected physical classification.

### BRIEF DESCRIPTION OF THE DRAWINGS

FIG. 1 depicts an example navigation system.

FIG. 2 depicts another example navigation system.

FIG. 3 depicts a block diagram of an example system that can be used to implement the examples described herein.

FIGS. 4 and 5 are flow diagrams of example methods that can be used to implement the examples described herein.

FIG. 6 is a schematic illustration of an example processor platform that may be used and/or programmed to implement any or all of the example methods and systems described herein.

The foregoing summary, as well as the following detailed description of certain examples, will be better understood when read in conjunction with the appended drawings. For the purpose of illustrating the examples described herein, certain examples are shown in the drawings. It should be understood, however, that the present disclosure is not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems and articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

The examples described herein enable users having different physical classifications to obtain routes that are tailored to their particular physical classification. To provide such tailored routes, the examples described herein collectively detect items of interest associated with the different physical classifications and use this collective information to develop safe up-to-date routes. In some examples, the items of interest and the routes may be dynamically updated by users of the system, map image analysis, satellite imagery analysis, government and municipal announcements and/or online information services and these updates may be conveyed to the user as the user proceeds on the route.

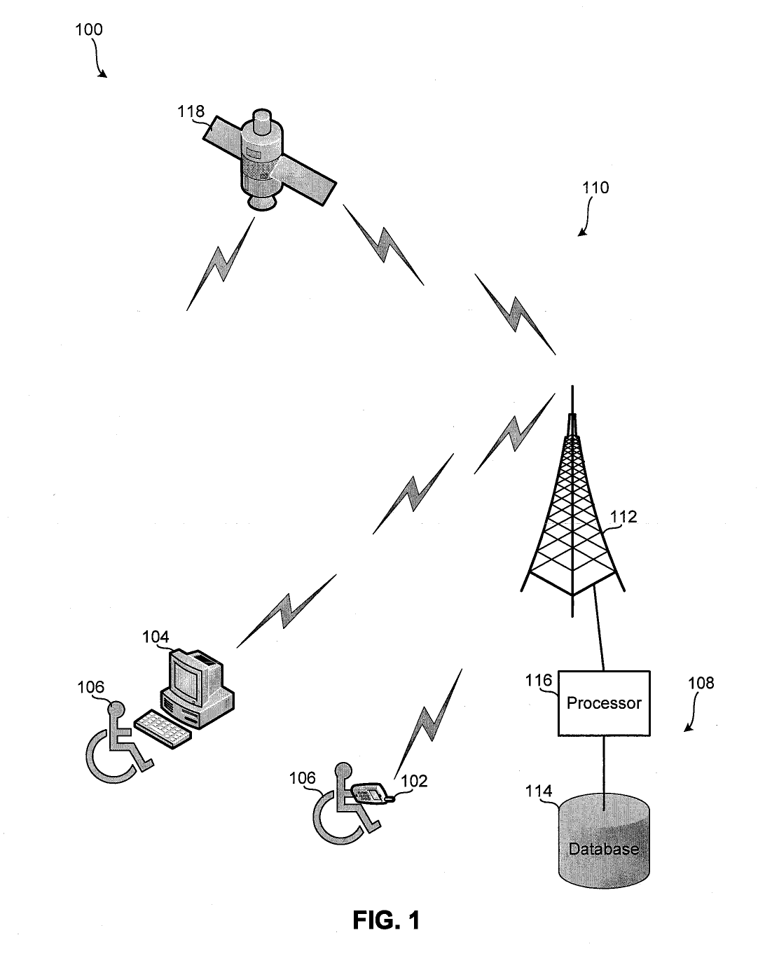

FIG. 1 depicts an example navigation system 100 that may be used to develop a route to a desired destination based on a user's physical classification. Such an approach enables users having different physical classifications to be provided with different routes that are suited or tailored to their particular physical classification, for example. The physical classification of the user may be associated with a physical handicap(s) or disability(ies) such as being wheelchair bound (e.g., permanently or temporarily), blind, visually impaired, mobility impaired or requiring assistance walking (e.g., crutches, walkers, canes). In other examples, the physical classification may be associated with the user's familiarity with the route or the safety of the route (e.g., crimes reported proximate the route, lighting along the route, traffic volume).

The example navigation system 100 may include a plurality of access devices such as a mobile device 102 and/or a personal computer 104 to enable users 106 to access the navigation system 100. Additionally, the navigation system 100 may include a command center 108 and utilize a location methodology 110 (e.g., Wireless Location, infrared (IR), global positioning system (GPS), cell/radio tower triangulation). The command center 108 may be communicatively coupled to the mobile device 102 and/or the personal computer 104 via a communication tower 112 and/or the internet.

The command center 108 may include a database 114 and/or a processor 116. The processor 116 may generate routes based, at least in part, on the physical classification of the user 106 and/or that accommodates the user's physical classification. The database 114 may include data associated with different routes and/or different physical classifications, for example. The generated route(s) may be conveyed to the mobile device 102 and/or the personal computer 104 via the communication tower 112. In some examples, the processor 116 may organize the information in the database 114 according to the associated physical classification. Additionally or alternatively, the information, including any recent updates, may be conveyed (e.g., automatically conveyed) by the processor 116 via the communication tower 112 to the mobile device 102 and/or the personal computer 104 to dynamically update the route previously conveyed, for example. In some examples, these updates may be conveyed to the user 106 as the route is being traveled by the user 106. While the processor 116 is depicted as separate from the mobile device 102 and/or the personal computer 104, the processor 116 may be at least partially implemented in the mobile device 102 and/or the personal computer 104. The location methodology 110 may include the communication tower 112 and/or a satellite 118; however, the location methodology 110 may include any additional or alternative elements to enable the navigation system 100 to locate the position of the user 106.

In operation, the user 106 may input their physical classification and the desired destination into the mobile device 102. For example, the user 106 may indicate that he is wheelchair bound and would like go to the public library (not shown). Additionally, the user 106 may specify that he has a manual wheelchair as opposed to an electric wheelchair, for example. In some examples, the user 106 may select a physical classification having a predefined set of criteria; however, the user 106 may modify or tailor the physical classification to better suit their particular physical classification.

To determine a feasible route to the public library, the navigation system 100 may initially determine the location of the user 106 using the location methodology 110. The location of the user 106 may then be conveyed to the processor 116 via the communication tower 112, for example. The processor 116 may then determine a route to the public library that is wheelchair friendly using data stored in the database 114 associated with the route and with the physical classification (e.g., the user 106 is in a manual wheelchair). Because the user 106 is in a wheelchair, the processor 116 may determine a route to the public library that is relatively clear of rough services (e.g., holes, stairs, hills, gravel paths, road construction) and that directs the user 106 to an entrance of the library having a wheelchair accessible ramp, for example. As the route is being determined, the processor 116 may additionally identify items of interest along the route to a person in a wheelchair. For example, if the route includes a raised portion of sidewalk, the processor 116 may include an identifier on the route to indicate the raised portion of sidewalk to the user 106.

Once determined, the processor 116 may convey information including the route and the items of interest to the mobile device 102 using the communication tower 112, for example. In some example, the information conveyed may include statistics and/or characteristics associated with the previous user that identified the item of interest. For example, the information may indicate that the previous user was in a manual wheelchair and has accurately identified an item of interest 75% of the time. In some examples, the information conveyed may include the number of users that have confirmed or denied the presence of, the statistical relevance of and/or the statistical probability of an item of interest along the route. In some examples, the information conveyed may identify the age of the information associated with the item of interest and/or the source(s) used in developing the route. Additionally or alternatively, the information conveyed may be associated with the reliability of the route, the likelihood of an incident and/or item of interest on the route and/or the percentage of the route that has been confirmed by others (e.g., other users) to be safe or unsafe for a particular physical classification, for example. In some examples, the information conveyed may include the amount of information associated with the route (e.g., amount of distribution of information throughout the route), the average date of information associated with the route and/or a map of the entire route. In some examples, the information conveyed may include the number of routes generated prior to developing the current route, the number of items of interest or data points along the route and/or an identifier that the route includes a compilation of routes and/or portions of routes traveled by other users, for example.

After the route is received by the user 106, the user 106 may proceed on the route to the public library. As the user 106 proceeds on the route, the location methodology 110 may determine the location of the user 106 on the route and, based on the location of the user 106, the mobile device 102 may indicate upcoming or proximate items of interest to the user 106. In some examples, the mobile device 102 may provide an indication of items of interest based on the direction the user 106 is headed or the direction the user 106 is facing. Additionally, as the user 106 proceeds on the route, the mobile device 102 may provide turn-by-turn directions to the public library. The directions may be audio directions provided by the mobile device 102 and/or they may be visual directions displayed on the mobile device 102, for example.

In other examples, the user 106 may input their physical classification and the desired destination into the personal computer 104. For example, the user 106 may indicate that she walks with a cane, may personalize her classification by including a preference that she needs to stop to rest every ⅛ mile and would like to go to the zoo (not shown). Additionally, the user 106 may input her current location or the start of the route into the personal computer 104. The personal computer 104 may then convey the physical classification including the preference, the start of the route and the destination to the processor 116. The processor 116 may determine a route to the zoo that better accommodates a walker using a cane using data stored in the database 114 associated with the route and with the physical classification (e.g., the user 106 walks with a cane). Because the user 106 walks with a cane, the processor 116 may determine a route to the zoo that is relatively clear of holes, rough surfaces, steps, uneven terrain and/or ice, for example. As the route is being determined, the processor 116 may additionally identify items of interest to a person that walks with a cane using data stored in the database 114. For example, because the user 106 indicated that she needs to rest every ⅛ mile, the processor 116 may include an identifier(s) on the route of such resting places. Additionally or alternatively, if the route includes a raised portion of sidewalk, the processor 116 may include an identifier on the route to indicate the raised portion of sidewalk to the user 106.

Once determined, the processor 116 may convey information including the route and the items of interest to the personal computer 104 for the user 106 to view and/or print to take with them as they proceed on the route. The information conveyed may include a map of the entire route including overlays of a plurality of different information that may be used by the user 106 in determining whether or not they would like to proceed on the route. The plurality of information may include the reliability of the route and the average date of information used to generate the route, for example. In such examples, the map of the entire route including overlays may include identifiers of the various types of information included. The information conveyed may include multiple views associated with the route and/or the items of interest. Some views may include an indication of the physical classification of users who have already used the same or a portion of the route and/or the amount of information association with a portion or the entire route. Additionally or alternatively, some views may include an indication of the reliability of the route and/or an indication of possible safety concerns associated with a portion of the route, for example. In still other examples, some views may include an indication of lighting conditions on a portion or the entire route.

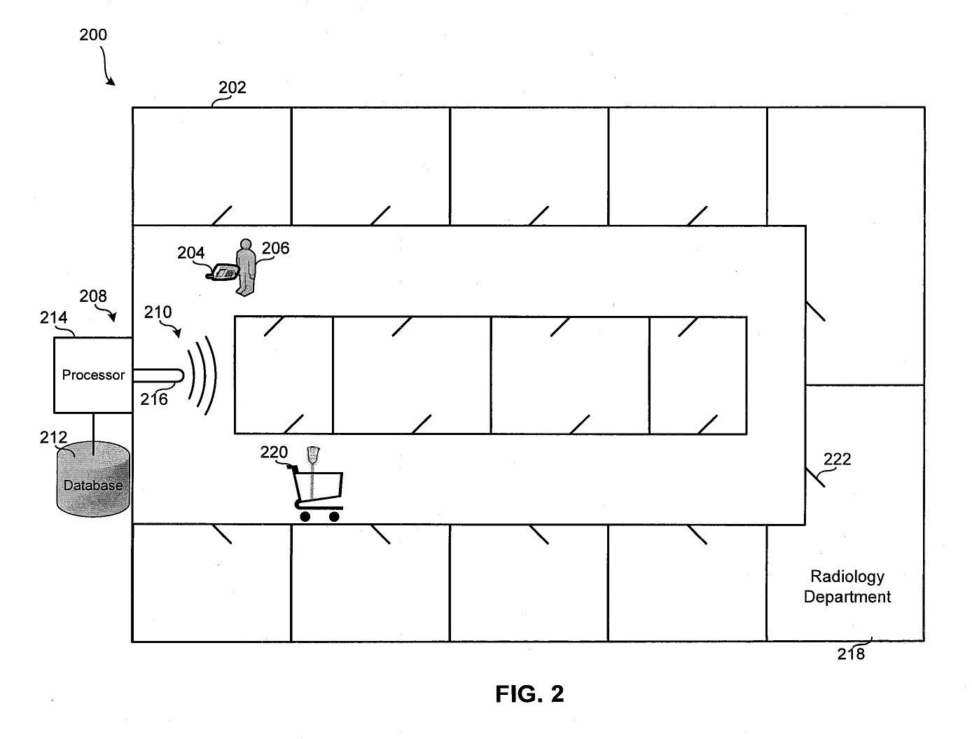

FIG. 2 depicts an example navigation system 200 that may be used to develop a route to a desired destination within a building 202 based on a user's physical classification. Such an approach enables users having different physical classifications to be provided with different routes that are suited or tailored to their physical classification, for example. The physical classification of the user may be associated with a physical handicap(s) or disability(ies) such as being wheelchair bound (e.g., permanently or temporarily), blind, visually impaired or requiring assistance walking (e.g., crutches, walkers, canes).

The example navigation system 200 may include one or more access devices 204 (e.g., mobile devices) to enable a user(s) 206 to access the navigation system 200. Additionally, the navigation system 200 may include a command center 208 and utilize location methodology 210 (e.g. IR). The command center 208 may be communicatively coupled to the access device 204 and may include a database 212 and a processor 214. While the processor 2214 is depicted as separate from the access device 204, the processor 214 may be at least partially implemented in the access device 204, for example. The location methodology 210 may include a sensor and/or antenna 216; however, the location methodology 210 may include any additional or alternative elements to enable the navigation system 200 to locate the position of the user 206 in the building 202, for example.

In operation, the user 206 may input their physical classification and the desired destination into the access device 204. Alternatively, building personnel (e.g., healthcare personnel) may issue the access device 204 to the user 206 having the user's 206 classification and desired destination(s) already entered. For example, healthcare personnel may input that the user 206 is blind and needs to go a radiology department 218 of the building 202.

To determine a feasible route to the radiology department 218, the navigation system 200 may initially determine the location of the user 206 within the building 202 using the location methodology 210 and/or the start of the route. The location of the user 206 may then be conveyed to the processor 214 and the processor 214 may then determine a route to the radiology department 218 that better accommodates the user 206 that is blind using data stored in the database 212 associated with the route and with the physical classification (e.g., the user 206 is blind). Because the user 206 is blind, the processor 214 may determine a route to the radiology department that is relatively free of small holes, irregular surfaces, stairs and/or obstacles. As the route is being determined, the processor 214 may additionally identify items of interest along the route to a person that is blind. For example, if the database 212 includes information that a cleaning cart 220 is positioned along the route, the processor 214 may include an identifier on the route to indicate the presence of the cleaning cart 220 to the user 224.

Once determined, the processor 214 may convey the route including the items of interest to the access device 204, for example. The user 206 may then proceed on the route to the radiology department 218. As the user 206 proceeds on the route, the location methodology 210 may determine the location of the user 206 on the route and, based on the location of the user 206, the access device 204 may indicate upcoming or proximate items of interest to the user 106. For example, as the user 206 approaches the cleaning cart 220, the access device 204 may alert the user 206 of the presence and location of the cleaning cart 220 to enable the user 206 to navigate around and to avoid a collision. Additionally, as the user 206 proceeds on the route, the access device 204 may provide turn-by-turn directions to an entrance 222 of the radiology department 218. Because the user 206 is blind, the directions may be audio directions provided by the access device 204; however, the directions may be visual directions displayed on the access device 204.

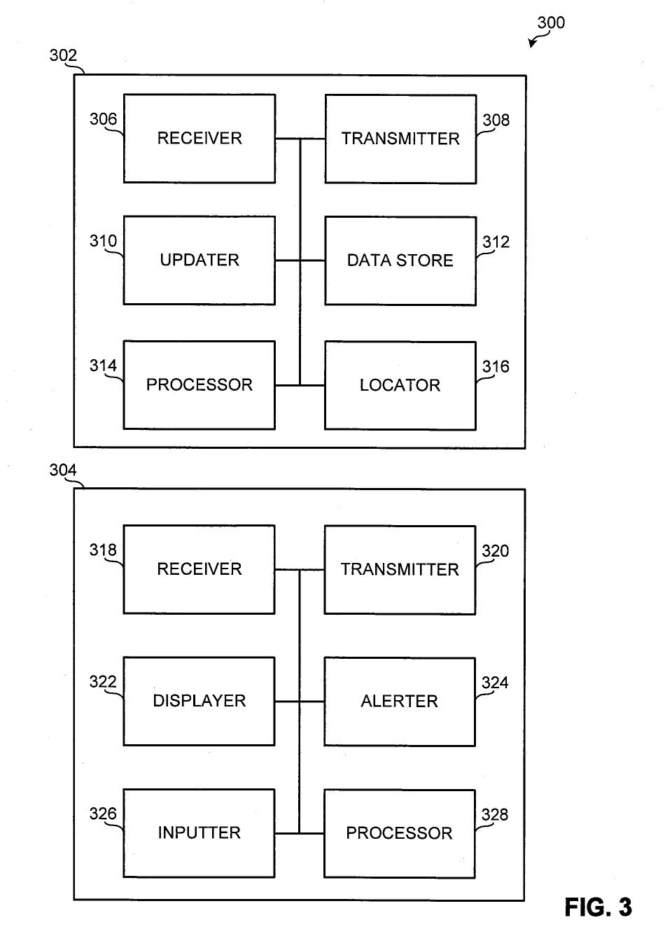

FIG. 3 is a schematic block diagram of a system 300 for developing a route(s) to a desired destination based on a user's physical classification. The system 300 includes a command center 302 to determine a route based on a user's physical classification and an access device 304 to enable a user to select a desired destination and the user's physical classification. The command center 302 may include a receiver 306, a transmitter 308, an updater 310, a data store 312, a processor 314 and/or a locator 316. The access device 304 may include a receiver 318, a transmitter 320, a displayer 322, an alerter 324, an inputter 326 and/or a processor 328.

In operation, a user may input their physical classification, the desired destination and/or any preferences into the inputter 326 of the access device 304. The inputter 326 may be, for example, a mouse, joystick, keyboard, track ball, touch activated screen, light wand, voice control, or any similar or equivalent input device. The transmitter 320 of the access device 304 may then transmit the information entered into the inputter 326 to the receiver 306 of the command center 302 where it then may be conveyed by the processor 314 to the data store 312 for storage.

To determine a feasible route to the desired destination, if the access device 304 is a hand-held device, the system 300 may initially determine the location of the user using the locator 316. The locator 316 may utilize any suitable technology to identify the location of the user such as, Wireless Location, IR, GPS and/or cell/radio tower triangulation, for example. The locator 316 may then transmit the location of the user to the data store 312 for storage where the user's location may later be retrieved by the processor 314.

The processor 314 may determine or find a route(s) to the destination from the user's current location, for example. Once the processor 314 determines if the user has entered any preferences and/or particular physical classifications, the route may be generated, adjusted and/or impassable routes may be eliminated from consideration. If the user enters a preference (e.g., route type) that they would like to take a scenic route, the processor 314 may adjust the route so that the route takes the user proximate the water front, for example. In other examples, if the user enters a preference that they would like to only walk on well lit streets or streets on which criminal activity has not recently been reported, the processor 314 may adjust the route so that routes having poor lighting and/or in which criminal activity has recently been reported are not included. Additionally or alternatively, if the user has entered a physical classification, the processor 314 may verify that the route is passable by a user having the particular physical classification.

The processor 314 may search the data store 312 to determine conditions (e.g., weather conditions, path quality, construction) associated with the route and/or if other users having the same or similar physical classifications have taken the same or at least a portion of the route. If other users have taken the same or at least a portion of the route, the processor 314 may evaluate any experiences (e.g., positive or negative) that the previous users have had on the route and the processor 314 may adjust the route accordingly. Based on previous users' experiences, the processor 314 may sort the routes such that routes on which users have had positive experiences are ranked higher and routes on which users have had negative experiences are ranked lower, for example. If a previous user in a manual wheelchair has input that he had had difficulty taking the route because of uneven terrain, the processor 314 may adjust the route to avoid the uneven terrain and/or the processor 314 may rank the route lower than a route that has been verified by a previous user as not having uneven terrain.

The processor 314 may then generate or select the most appropriate route based on the user preferences and/or the physical classification(s). Additionally, the processor 314 may search the data store 312 to determine if the updater 310 has added any inputs (e.g., inputs from other users, inputs relating to weather, inputs relating to the condition of the route, etc.) that may affect the route. For example, if another user has recently input that a tree has fallen over a portion of the route, the processor 314 may adjust the route so that the user avoids colliding with the tree.

Once the route is generated, the transmitter 308 may transmit the route to the receiver 318 of the access device 304 where the route may be displayed to the user using the displayer 322. As the user proceeds on the route, the locator 316 may determine the location of the user on the route and, based on the location of the user, the alerter 324 may indicate upcoming or proximate items of interest to the user. For example, as the user approaches the tree that fell over a portion of the route, the alerter 324 may alert the user of the tree as the user approaches it. Additionally, as the user approaches the tree, the access device 304 may provide directions to navigate the user around the tree to avoid a collision.

As the user proceeds on the route, the access device 304 may provide turn-by-turn directions to the destination. The directions may be audio directions provided by the access device 304 and/or they may be visual directions displayed using the displayer 322, for example. As the user proceeds on the route, the updater 310 may search for updates that may affect the route. Some updates may include updates input by other users and/or updates associated with recent news reports, for example. If the updater 310 identifies an update, the processor 314 may dynamically update or adjust the route accordingly and have the updated route transmitted to the access device 304 via the transmitter 308 where the updated route may be viewed by the user, for example.

In some examples, as the user proceeds on the route, the user may input updates to the route and/or items of interest associated with the route using the inputter 326. The location of such updates and/or items of interest on the route may be determined based on the location of the user when the update and/or item of interest was identified and input into the access device 304, for example. The updates and/or items of interest may be conveyed by the transmitter 320 to the receiver 306 and to the data store 312 where the updates and/or items of interest may be used to update future routes.

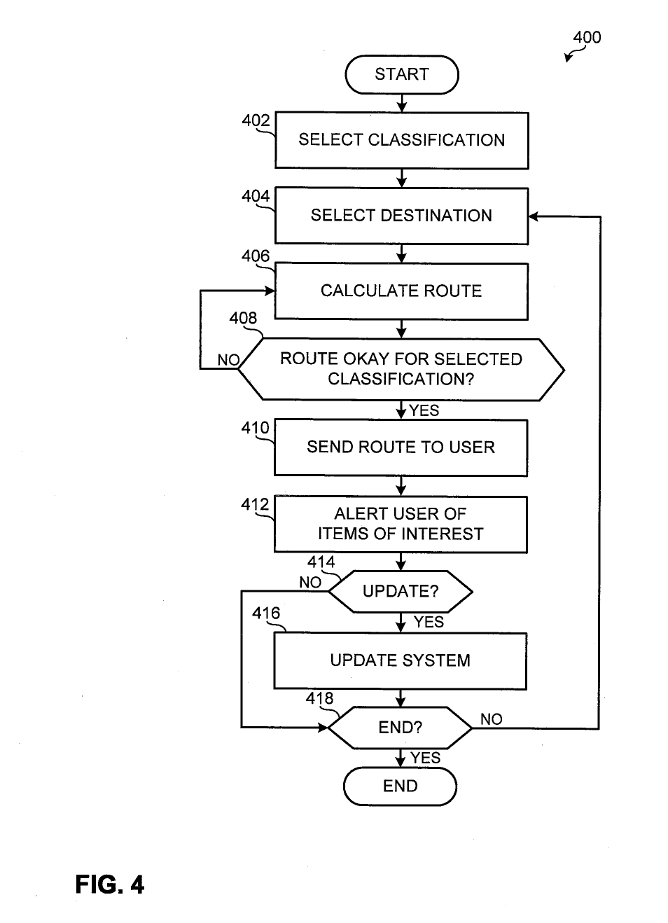

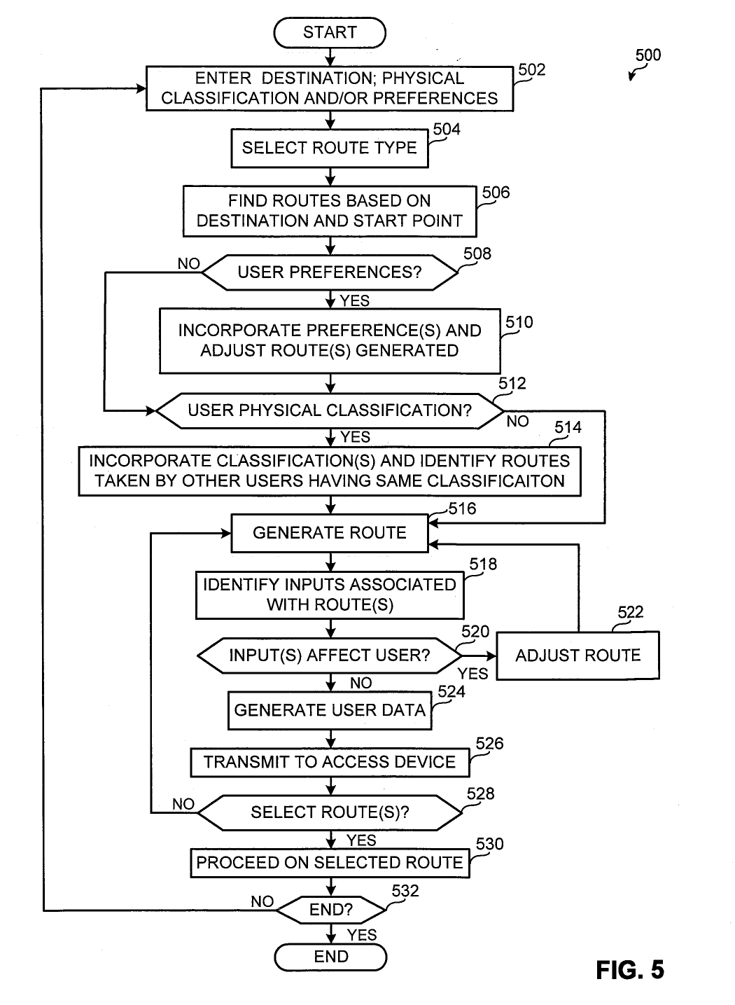

The flow diagrams depicted in FIGS. 4 and 5 are representative of machine readable instructions that can be executed to implement the examples described herein to develop a route to a desired destination based on a user's physical classification. The example processes of FIGS. 4 and 5 may be performed using a processor, a controller and/or any other suitable processing device. For example, the example processes of FIGS. 4 and 5 may be implemented in coded instructions stored on a tangible medium such as a flash memory, a read-only memory (ROM) and/or random-access memory (RAM) associated with a processor (e.g., the example processor 116, 214, 314 and/or 328). Alternatively, some or all of the example processes of FIGS. 4 and 5 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 4 and 5 may be implemented manually or as any combination(s) of any of the foregoing techniques, for example, any combination of firmware, software, discrete logic and/or hardware. Further, although the example processes of FIGS. 4 and 5 are described with reference to the flow diagrams of FIGS. 4 and 5, other methods of implementing the processes of FIGS. 4 and 5 may be employed. For example, the order of execution of the blocks may be changed, and/or some of the blocks described may be changed, eliminated, sub-divided, or combined. Additionally, any or all of the example processes of FIGS. 4 and 5 may be performed sequentially and/or in parallel by, for example, separate processing threads, processors, devices, discrete logic, circuits, etc.

Turning to FIG. 4, an example method 400 may begin by having a user select a physical classification (block 402) and a destination (block 404). The user may select the physical classification and/or the destination by inputting the information into the mobile device 102, the personal computer 104, the access device 204 and/or the inputter 326 of the access device 304. Additionally, the user may identify the start of the route and/or the location methodology 110, 210 and/or the locator 316 may identify the location of the user.

The method 400 may then calculate or determine the route to the destination (block 406) and then verify that the route is okay for the selected physical classification (block 408), including the user's mobility level, using the processor 116, 214, 314 and/or 328 and data stored in the database 114, 212 and/or the data store 312, for example. The physical classification may be associated with a handicap or disability of the user or the physical classification may be associated with preferences that the user has regarding the route. If the physical classification is that the user uses a wheelchair, some concerns associated with potential routes may be that the route is substantially free of holes, rough surfaces and/or stairs. Additionally, the mobility of the user using a wheelchair may vary from low to high depending on whether the user uses a manual wheelchair or an electric wheelchair, for example. Some specific requirements that may be associated with users in wheelchairs are that the routes for such users should direct them to wheelchair accessible entrances or the user may be need assistance if no wheelchair accessible entrances are available.

If the physical classification is that the user is blind, some concerns associated with potential routes may be that the route is substantially free of small holes, irregular surfaces, stairs and/or obstacles (e.g., traffic, trees, walls). Additionally, the mobility of users that are blind may vary from low to medium depending on the training of the user and/or any equipment (e.g., a white cane) that may assist the user in travel. Some specific requirements that may be associated with users that are blind are that some users may have a seeing eye dog, which may add additional considerations when calculating or determining the route.

If the physical classification is that the user has limited visual impairments, some concerns associated with potential routes may be that the route is substantially free of small holes, irregular surfaces and/or small obstacles. Additionally, the mobility of users having limited visual impairments may vary from low to high depending on their visual issues and/or the visibility at the time of travel (e.g., the amount of daylight). Some specific requirements that may be associated with users having limited visual impairments is that the route should be relatively well lit, for example.

If the physical classification is that the user needs assistance walking (e.g., crutches, walker, cane), some concerns associated with potential routes may be that the route is substantially free of holes, rough surfaces, steps, uneven terrain and/or ice. Additionally, the mobility of the user may be low to medium depending on the type and kind of assistance that the user requires. Some specific requirements that may be associated with users needing assistance walking would be that the users may require places to rest and/or places to elevate their legs, for example.

If the physical classification is associated with the user's familiarity with the area, the potential routes may include places of interest, easy to remember routes and/or sight seeing destinations (e.g., famous things and/or places). If the physical classification is associated with safety, some concerns associated with potential routes may be that the route substantially avoids unsafe neighborhoods, unlit areas, unsafe crosswalks, unsafe tunnels and/or unsafe bridges, for example. Some specific requirements that may be associated with safety would be avoiding routes on which a crime(s) has occurred and/or that has relatively high traffic, for example.

If the route is not okay for the selected physical classification, control advances to block 406. However, if the route is okay for the selected physical classification, control advances to block 410. The method 400 then sends the route to the user (block 410). In some examples, the route may be sent to the mobile device 102, the personal computer 104 and/or the access device 204 and/or 304; however, the route may be conveyed to the user in any other suitable manner.

The method 400 may additionally alert the user of items of interest along the route (block 412). In some examples, an item of interest may be an obstacle and/or impairment in the route that the user should avoid, an appropriate route of entry into a building based on the user's physical classification (e.g., wheelchair accessible), the location of Braille signs, closed paths and/or the type of surface (e.g., concrete, dirt, gravel) associated with a portion of the route. In some examples, the items of interest may be associated with known safe routes for a particular physical classification, the safety of a particular intersection (e.g., the number of accidents reported) and/or the presence or absence of pedestrian walk-ways or tunnels along the route (e.g., pedestrian walk-way on a bridge). In some examples, the items of interest may be associated with a bathroom at an event (e.g., baseball game) that has a relatively short line, the lighting conditions along the route and/or the location of street lamps that are broken. In other examples, an item of interest may be a place where the user may elevate their legs and/or a sight seeing destination.

As the user proceeds on the route and approaches an item of interest, the mobile device 102 and/or the access device 204 and/or 304 may alert the user of the presence of the item of interest and/or navigate the user around the item of interest. In other examples, the item of interest may be displayed on the mobile device 102, the personal computer 104 and/or the access device 204 and/or 304 by a descriptive icon, for example.

As the user proceeds on the route, the user may identify items of interest that may be used to dynamically update the route and/or the system. If the user determines that they would like to update the system (block 414), control advances to block 416 and the system may then be updated. The items of interest identified by the user may be transmitted to the database 114, 212 and/or the data store 312 where this information may be organized by the processor 116, 214, 314 and/or 328 based on the associated physical classification, for example. If the user determines that they do not want to update the system, control advances to block 418. The method 400 may then determine whether or not the user would like to select another destination (block 418); otherwise the example method 400 is ended.

Turning to FIG. 5, an example method 500 may begin by having a user enter a destination, a physical classification and/or a preference(s) (block 502). The user may input the destination, the physical classification and/or any preferences into the mobile device 102, the personal computer 104, the access device 204 and/or the inputter 326 of the access device 34. Some physical classifications may be associated with a handicap or disability (e.g., visually impaired, mobility impaired) of the user and some preferences may be associated with the user preferring to take a route that is relatively well lit, is a safe route and/or avoids particular places or things, for example. The user may then select a route type (block 504). The route type may be associated with the user's mode of travel such as, walking, public transportation or driving, for example. In other examples, the route type may be associated with the quickest route, a standard route or a scenic route.

The method 500 may then find potential routes based on the destination, the start point (block 506) and/or the route type. In some example, the processor 116, 214, 314 and/or 328 may find routes using data stored in the database 114, 212 and/or the data store 312. The method 500 may then determine if the user has entered any preferences (block 508). If the user has entered a preference(s), the method 500 may incorporate the preference(s) and adjust the route(s) generated (block 510) accordingly. For example, if the user has selected a preference that they would like to go on a route that avoids tunnels, the method 500 may adjust the route accordingly, for example. However, if the user did not enter any preferences, control advances to block 512.

The method 500 may then determine if the user has entered a physical classification (block 512). If the user has entered a physical classification, the method may incorporate the physical classification and adjust the route(s) generated (block 514) accordingly. For example, if the user selected a physical classification that they are in a wheelchair, the method 500 may include in the route directions to a wheelchair accessible entrance of a building, for example. However, if the user did not enter a physical classification, control advances to block 516.

The method 500 may then generate a route (block 516) and indentify any inputs or data associated with the route(s) (block 518). The inputs or data may be associated with user inputs, map image analysis, satellite imagery analysis, government and/or municipal announcements and/or online information services and may be obtained by the updater 310, for example. The method 500 then determines whether or not any of the updates affect the user (block 520). For example, if an update is associated with construction beginning on a section of the generated route making the route impassable by the user, control may advance to block 522 and the route may be adjusted. However, if the inputs do not substantially affect the user, control may advance to block 524.

The method 500 may then generate user data (block 524) and transmit the route to the access device (e.g., the mobile device 102, the personal computer 104 and/or the access device 204 and/or 304) (block 526). In some examples, the user data may include the route(s) and/or items of interest identified on the route. Additionally or alternatively, the user data may be associated with portions of the route taken by other users having the same or similar physical classifications and/or the source of the information associated with the route and/or an item of interest(s), for example. If more than one route is transmitted to the user, the routes may be sorted by the user and/or the processor 116, 214, 314 and/or 328 based on the number of users having the same or similar classification that have taken the route, the distance of the route, the items of interest on the particular route, the accuracy of the route, specific criteria or preferences entered by the user, the business of the routes (e.g., amount of traffic) and/or the condition of the routes, for example. Additionally or alternatively, the user may switch between different views of the route(s). For example, a first view of the route may depict items of interest on the route(s), a second view of the route may depict portions of the route that have been traveled by other users and/or a third view may include experiences other users have had on the route.

Additionally or alternatively, the route may include color coding that identifies portions of the route that have been traveled by other users and/or to identify the source of where the information associated with the route and/or an item of interest was obtained. For example, portions of the route that have been traveled on and/or verified by other users may be green, while portions of the route that have not been traveled on and/or verified by other users may be red. Additionally or alternatively, items of interest that have been input by other users may be identified with the color blue, while items of interest that have been obtained by the department of transportation may be identified with the color yellow, for example.

The user may then select or accept the route transmitted to the access device (block 528) and then proceed on the selected route (block 530). In some examples, the user may decide whether or not to proceed on a route based on the length of the route and/or the amount of the route that has been verified by users having the same or similar physical classifications. However, if the user does not select any of the transmitted routes, control advances to block 516. The method 500 may then determine whether or not the user would like to select another destination, physical classification and/or preference (block 532); otherwise the example method 500 is ended.

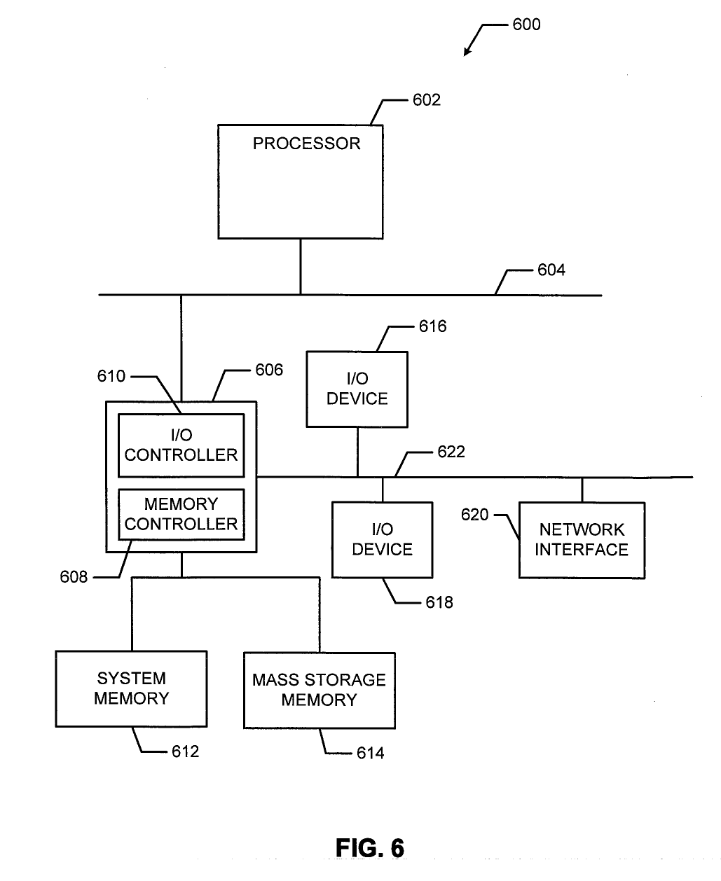

FIG. 6 is a block diagram of an example processor system 600 that may be used to implement the systems and methods described herein. As shown in FIG. 6, the processor system 600 includes a processor 602 that is coupled to an interconnection bus 604. The processor 602 may be any suitable processor, processing unit or microprocessor. Although not shown in FIG. 6, the processor system 600 may be a multi-processor system and, thus, may include one or more additional processors that are identical or similar to the processor 602 and that are communicatively coupled to the interconnection bus 604.

The processor 602 of FIG. 6 is coupled to a chipset 606, which includes a memory controller 608 and an input/output (I/O) controller 610. As is well known, a chipset typically provides I/O and memory management functions as well as a plurality of general purpose and/or special purpose registers, timers, etc. that are accessible or used by one or more processors coupled to the chipset 606. The memory controller 608 performs functions that enable the processor 602 (or processors if there are multiple processors) to access a system memory 612 and a mass storage memory 614.

The system memory 612 may include any desired type of volatile and/or non-volatile memory such as, for example, static random access memory (SRAM), dynamic random access memory (DRAM), flash memory, read-only memory (ROM), etc. The mass storage memory 614 may include any desired type of mass storage device including hard disk drives, optical drives, tape storage devices, etc.

The I/O controller 610 performs functions that enable the processor 602 to communicate with peripheral input/output (I/O) devices 616 and 618 and a network interface 620 via an I/O bus 622. The I/O devices 616 and 618 may be any desired type of I/O device such as, for example, a keyboard, a video display or monitor, a mouse, etc. The network interface 620 may be, for example, an Ethernet device, an asynchronous transfer mode (ATM) device, an 802.11 device, a DSL modem, a cable modem, a cellular modem, etc. that enables the processor system 600 to communicate with another processor system.

While the memory controller 608 and the I/O controller 610 are depicted in FIG. 6 as separate blocks within the chipset 606, the functions performed by these blocks may be integrated within a single semiconductor circuit or may be implemented using two or more separate integrated circuits.

Certain example implementations contemplate methods, systems and computer program products on any machine-readable media to implement functionality described above. Certain example implementations may be implemented using an existing computer processor, or by a special purpose computer processor incorporated for this or another purpose or by a hardwired and/or firmware system, for example.

Certain example implementations include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

The example methods and apparatus described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The example methods and apparatus described herein may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A method of navigating a user to a destination based on a selected physical classification, comprising:
identifying, based on user selection, the physical classification associated with the user and the destination;
determining a route to the destination to accommodate the selected physical classification;
conveying the route to the user; and
alerting the user of one or more items of interest associated with the selected physical classification and the determined route.

2. The method of claim 1, further comprising alerting the user of one or more items of interest associated with the selected physical classification and the determined route as the user proceeds on the route.

3. The method of claim 1, wherein the one or more items of interest comprise obstacles or impairments in the route.

4. The method of claim 1, further comprising conveying to the user information associated with one or more previous users and the determined route.

5. The method of claim 1, further comprising dynamically updating the route based on current information associated with the route and conveying the updated route to the user.

6. The method of claim 1, further comprising enabling the user to dynamically update the route.

7. The method of claim 1, further comprising enabling the user to dynamically update the route based on one or more identified items of interest as the user proceeds on the route.

8. The method of claim 1, wherein determining the route to the destination to accommodate the selected physical classification comprises verifying that the route is passable by the user based on the selected physical classification.

9. The method of claim 1, wherein determining the route to the destination to accommodate the selected physical classification comprises at least identifying conditions on potential routes.

10. The method of claim 1, wherein conveying the route to the user comprises conveying the route to the user by a mobile device.

11. The method of claim 1, wherein the selected physical classification comprises at least one of visually impaired or mobility impaired.

12. The method of claim 1, wherein selecting the physical classification and the destination comprises selecting the associated classification and the destination using a mobile device.

13. The method of claim 1, further comprising enabling the user to tailor the selected physical classification.

14. The method of claim 1, further comprising enabling the user to modify the selected physical classification.

15. The method of claim 1, wherein determining the route to the destination based on the selected physical classification comprises at least determining an appropriate route of entry into a building based on the selected physical classification.

16. A tangible machine readable medium having instructions stored thereon that, when executed, cause a machine to:
identify, based on user selection, a physical classification associated with the user and a destination;
determine a route to the destination to accommodate the selected physical classification;
convey the route to the user; and
alert the user of one or more items of interest associated with the selected physical classification and the determined route.

17. The tangible machine readable medium of claim 16 having instructions stored thereon that, when executed, cause the machine to convey to the user information associated with one or more previous users and the determined route.

18. The tangible machine readable medium of claim 16 having instructions stored thereon that, when executed, cause the machine to dynamically update the route based on current information associated with the route and convey the updated route to the user.

19. The tangible machine readable medium of claim 16 having instructions stored thereon that, when executed, cause the machine to enable the user to dynamically update the route.

20. A system configured to navigate a user to a destination based on a selected physical classification, comprising:
a processor configured to determine a route to the destination based on the selected physical classification, wherein the processor is to convey the route to the user; and
a data store to store data associated with the route and the selected physical classification.

21. The system of claim 20, wherein conveying the route to the user comprises conveying the route to a mobile device.

22. The system of claim 20, wherein conveying the route to the user comprises conveying the route to an access device.

23. The system of claim 22, wherein the access device comprises a computer.

24. The system of claim 20, further comprising a mobile device to enable the user to select the physical classification and the destination.

25. The system of claim 20, wherein the processor and the data store are associated with a command center.
